(19) United States
(12) Patent Application Publication
(10) Pub. No.: US 2023/0319913 A1
(43) Pub. Date: Oct. 5, 2023

(54) AUTHORIZATION OF COMMAND AND CONTROL COMMUNICATIONS VIA DIRECT LINK

(71) Applicant: QUALCOMM Incorporated, San Diego, CA (US)

(72) Inventors: Sunghoon KIM, San Diego, CA (US); Stefano FACCIN, San Ysidro, CA (US); Drew Foster VAN DUREN, Templeton, CA (US)

(21) Appl. No.: 18/061,780

(22) Filed: Dec. 5, 2022

Related U.S. Application Data
(60) Provisional application No. 63/362,437, filed on Apr. 4, 2022.

(51) Int. Cl. H04W 76/14; H04W 76/30; H04W 12/06

(52) U.S. Cl. CPC H04W 76/14; H04W 76/30; H04W 12/06; H04W 92/18

(57) ABSTRACT

Various aspects of the present disclosure generally relate to wireless communication. In some aspects, a network entity may receive, from an application server, an authorization request for command and control (C2) communications via a direct link between a pair of user equipments (UEs), wherein the authorization request indicates a proximity-based services (ProSe) identifier associated with the C2 communications. The network entity may transmit, to the application server, an authorization indication for the C2 communications via the direct link between the pair of UEs, wherein the authorization indication indicates a destination layer-2 identifier associated with the ProSe identifier. Numerous other aspects are described.

### CROSS-REFERENCE TO RELATED APPLICATION

This Patent application claims priority to U.S. Provisional Patent Application No. 63/362,437, filed on Apr. 4, 2022, entitled “AUTHORIZATION OF COMMAND AND CONTROL COMMUNICATIONS VIA DIRECT LINK,” and assigned to the assignee hereof. The disclosure of the prior application is considered part of and is incorporated by reference into this Patent Application.

### FIELD OF THE DISCLOSURE

Aspects of the present disclosure generally relate to wireless communication and to techniques and apparatuses for authorization of command and control (C2) communications via a direct link.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first user equipment (UE) for wireless communication. The first UE may include a memory and one or more processors coupled to the memory. The one or more processors may be configured to receive an indication of a proximity-based services (ProSe) identifier associated with authorized command and control (C2) communications via a direct link between the first UE and a second UE and an indication of a destination layer-2 identifier associated with the ProSe identifier. The one or more processors may be configured to establish a direct link with the second UE based at least in part on the ProSe identifier and the destination layer-2 identifier.

Some aspects described herein relate to a network entity for wireless communication. The network entity may include a memory and one or more processors coupled to the memory. The one or more processors may be configured to receive, from an application server, an authorization request for C2 communications via a direct link between a pair of UEs, wherein the authorization request indicates a ProSe identifier associated with the C2 communications. The one or more processors may be configured to transmit, to the application server, an authorization indication for the C2 communications via the direct link between the pair of UEs, wherein the authorization indication indicates a destination layer-2 identifier associated with the ProSe identifier.

Some aspects described herein relate to a method of wireless communication performed by a first UE. The method may include receiving an indication of a ProSe identifier associated with authorized C2 communications via a direct link between the first UE and a second UE and an indication of a destination layer-2 identifier associated with the ProSe identifier. The method may include establishing a direct link with the second UE based at least in part on the ProSe identifier and the destination layer-2 identifier.

Some aspects described herein relate to a method of wireless communication performed by a network entity. The method may include receiving, from an application server, an authorization request for C2 communications via a direct link between a pair of UEs, wherein the authorization request indicates a ProSe identifier associated with the C2 communications. The method may include transmitting, to the application server, an authorization indication for the C2 communications via the direct link between the pair of UEs, wherein the authorization indication indicates a destination layer-2 identifier associated with the ProSe identifier.

Some aspects described herein relate to a non-transitory computer-readable medium that stores a set of instructions for wireless communication by a first UE. The set of instructions, when executed by one or more processors of the UE, may cause the UE to receive an indication of a ProSe identifier associated with authorized C2 communications via a direct link between the first UE and a second UE and an indication of a destination layer-2 identifier associated with the ProSe identifier. The set of instructions, when executed by one or more processors of the UE, may cause the UE to establish a direct link with the second UE based at least in part on the ProSe identifier and the destination layer-2 identifier.

Some aspects described herein relate to a non-transitory computer-readable medium that stores a set of instructions for wireless communication by a network entity. The set of instructions, when executed by one or more processors of the network entity, may cause the network entity to receive, from an application server, an authorization request for C2 communications via a direct link between a pair of UEs, wherein the authorization request indicates a ProSe identifier associated with the C2 communications. The set of instructions, when executed by one or more processors of the network entity, may cause the network entity to transmit, to the application server, an authorization indication for the C2 communications via the direct link between the pair of UEs, wherein the authorization indication indicates a destination layer-2 identifier associated with the ProSe identifier.

Some aspects described herein relate to an apparatus for wireless communication. The apparatus may include means for receiving an indication of a ProSe identifier associated with authorized C2 communications via a direct link between the apparatus and a UE and an indication of a destination layer-2 identifier associated with the ProSe identifier. The apparatus may include means for establishing a direct link with the UE based at least in part on the ProSe identifier and the destination layer-2 identifier.

Some aspects described herein relate to an apparatus for wireless communication. The apparatus may include means for receiving, from an application server, an authorization request for C2 communications via a direct link between a pair of UEs, wherein the authorization request indicates a ProSe identifier associated with the C2 communications. The apparatus may include means for transmitting, to the application server, an authorization indication for the C2 communications via the direct link between the pair of UEs, wherein the authorization indication indicates a destination layer-2 identifier associated with the ProSe identifier.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of unmanned aerial vehicles (UAVs) within a wireless communication network environment, in accordance with the present disclosure.

FIG. 6 is a diagram illustrating an example associated with authorization of command and control (C2) communications via a direct link, in accordance with the present disclosure.

FIGS. 7-8 are diagrams illustrating example processes associated with authorization of C2 communications via a direct link, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

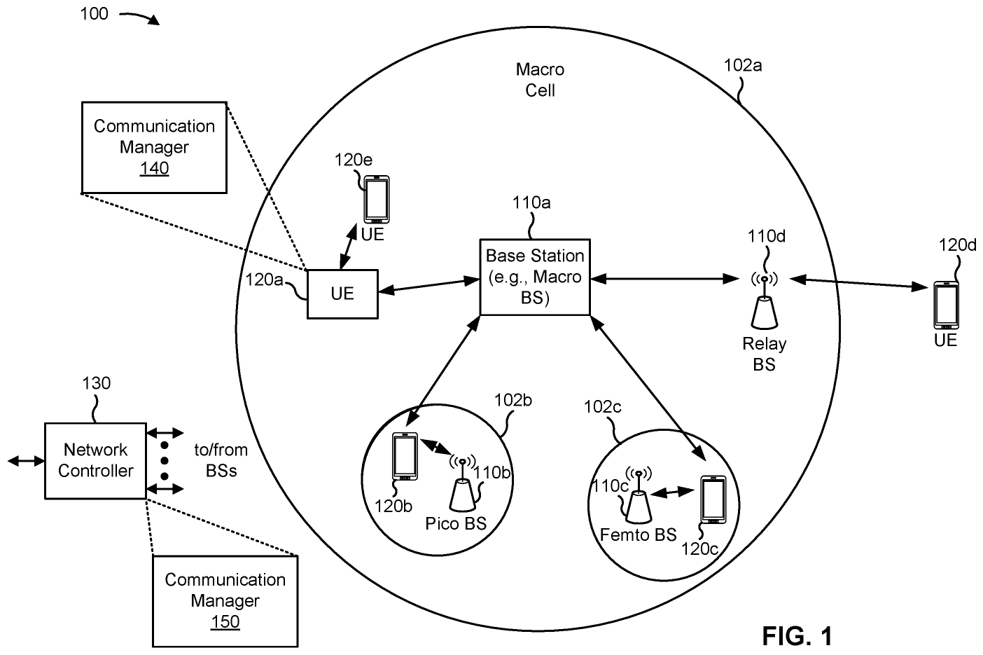

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle (UAV) (e.g., a drone), a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a proximity-based services (ProSe) identifier associated with authorized command and control (C2) communications via a direct link between the UE and another UE and an indication of a destination layer-2 identifier associated with the ProSe identifier; and establish a direct link with the other UE based at least in part on the ProSe identifier and the destination layer-2 identifier. Additionally, or alternatively, the communication manager 140 may perform one or more other operations described herein.

In some aspects, a network entity, such as the network controller 130, may include a communication manager 150. As described in more detail elsewhere herein, the communication manager 150 may receive an authorization request for C2 communications via a direct link between a pair of UEs, wherein the authorization request indicates a ProSe identifier associated with the C2 communications; and transmit an authorization indication for the C2 communications via the direct link between the pair of UEs, wherein the authorization indication indicates a destination layer-2 identifier associated with the ProSe identifier. Additionally, or alternatively, the communication manager 150 may perform one or more other operations described herein.

As indicated above, FIG. 1 is provided as an example. Other examples may differ from what is described with regard to FIG. 1.

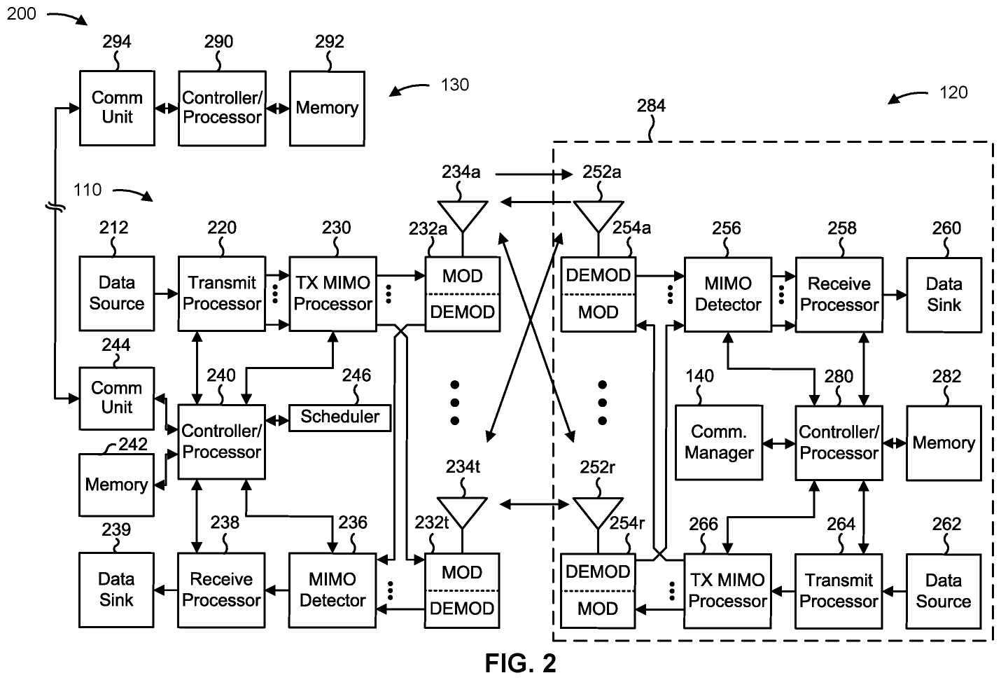

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

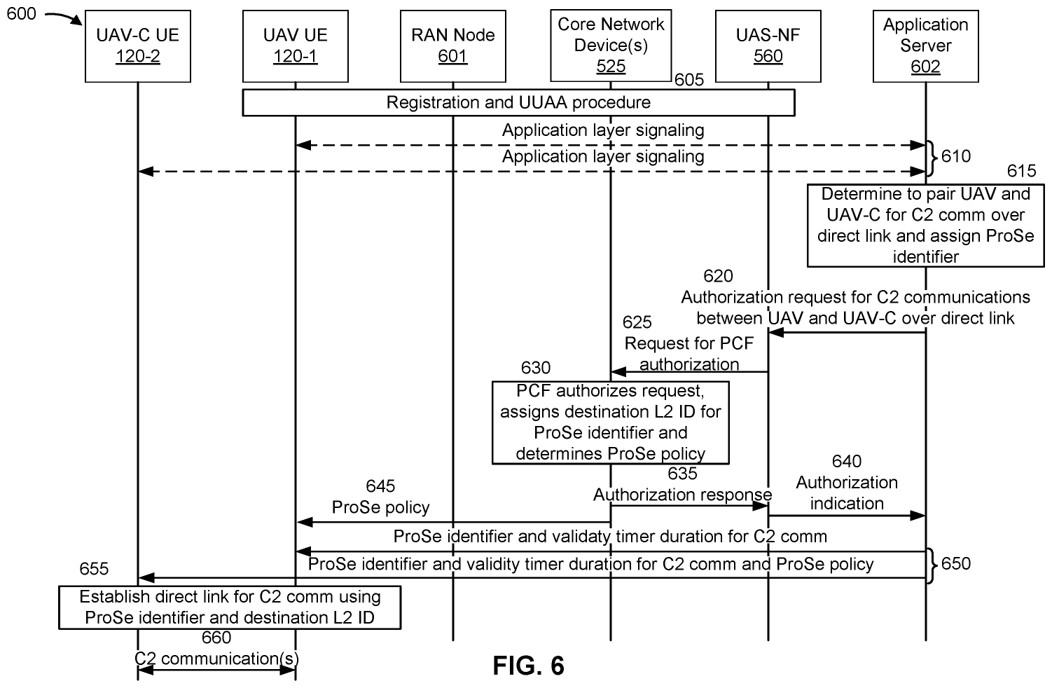

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

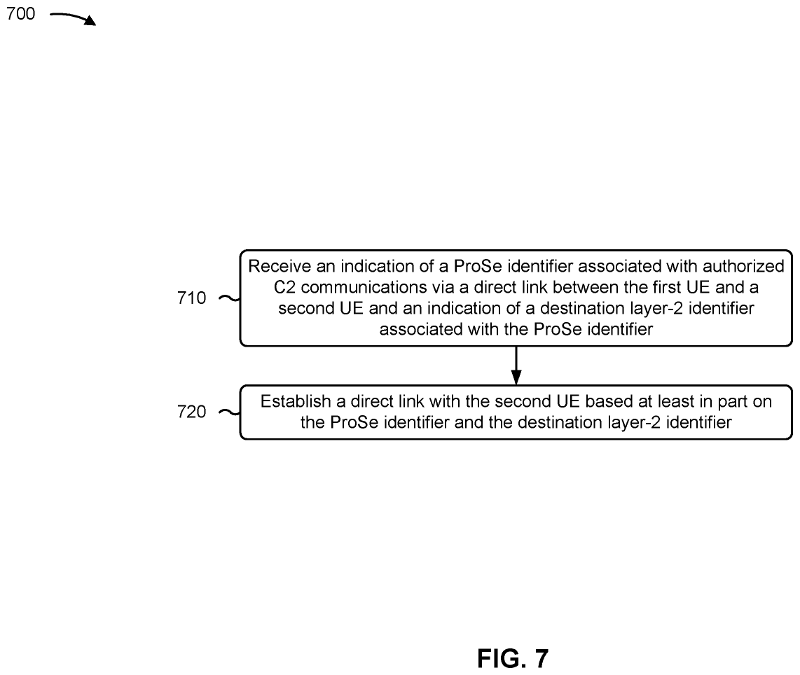

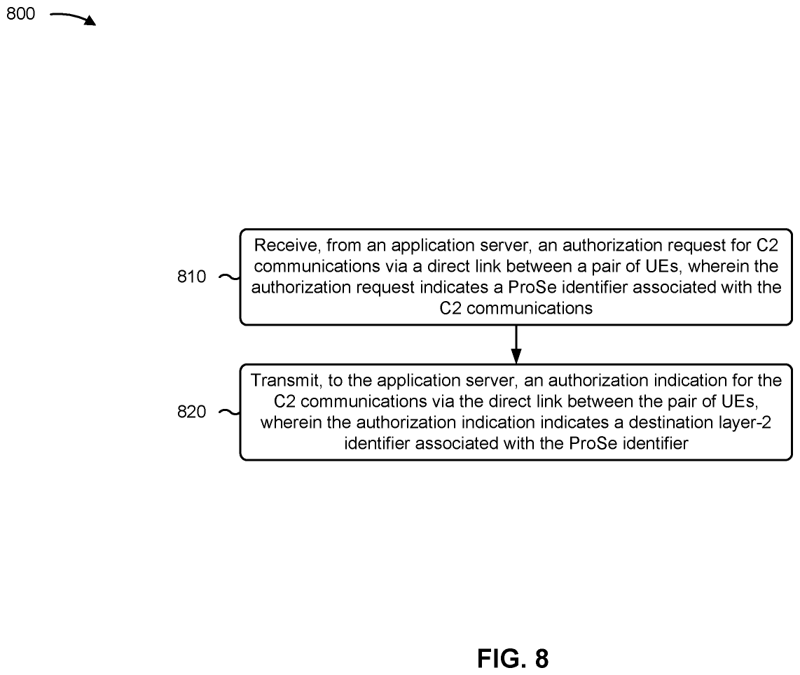

The controller/processor 240 of the base station 110, the controller/processor 280 of the UE 120, the controller/processor 290 of the network controller 130, and/or any other component(s) of FIG. 2 may perform one or more techniques associated with authorization of C2 communications via a direct link, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 8, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, the base station 110, and/or the network controller 130 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples. In some aspects, the network entity described herein may be, may be included in, or may include one or more components of the network controller 130 (as shown in FIG. 2), a core network device, or another network device.

In some aspects, a UE (e.g., UE 120) includes means for receiving an indication of a ProSe identifier associated with authorized C2 communications via a direct link between the UE and another UE and an indication of a destination layer-2 identifier associated with the ProSe identifier; and/or means for establishing a direct link with the other UE based at least in part on the ProSe identifier and the destination layer-2 identifier. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity includes means for receiving, from an application server, an authorization request for C2 communications via a direct link between a pair of UEs, wherein the authorization request indicates a ProSe identifier associated with the C2 communications; and/or means for transmitting, to the application server, an authorization indication for the C2 communications via the direct link between the pair of UEs, wherein the authorization indication indicates a destination layer-2 identifier associated with the ProSe identifier. In some aspects, the means for the network entity to perform operations described herein may include, for example, one or more of communication manager 150, communication unit 294, controller/processor 290, or memory 292.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a base station (such as a Node B (NB), evolved NB (eNB), NR base station, 5G NB, access point (AP), a TRP, or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base-station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

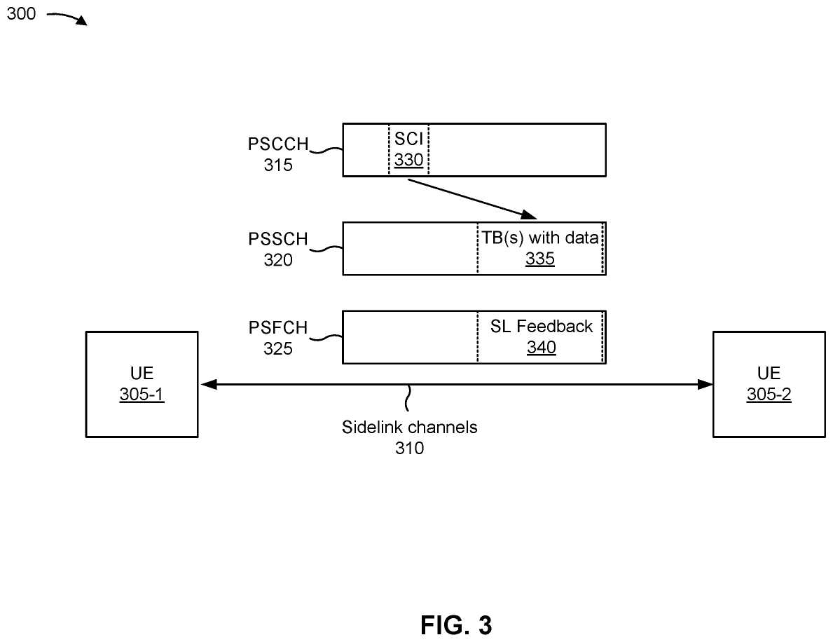

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink resource allocation mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a resource allocation mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the resource allocation mode where resource selection and/or scheduling is performed by a UE 305 (e.g., Mode 2), the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

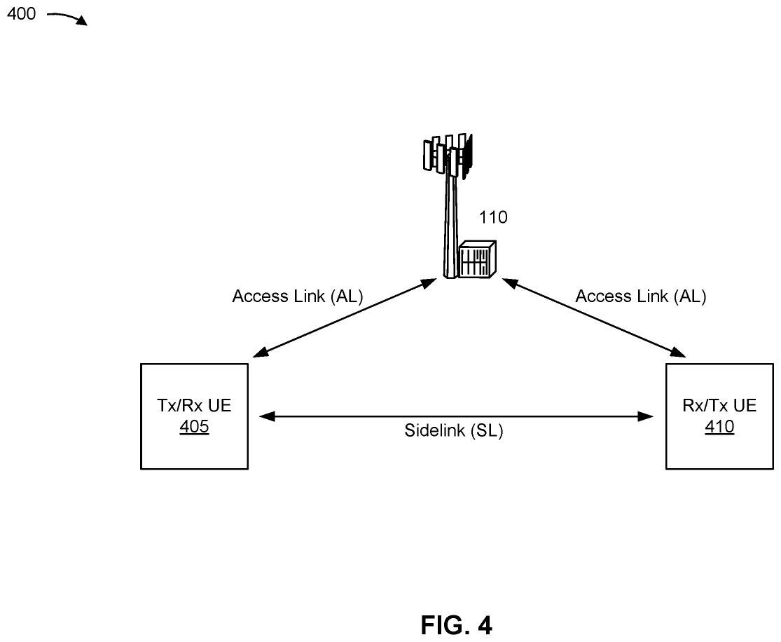

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

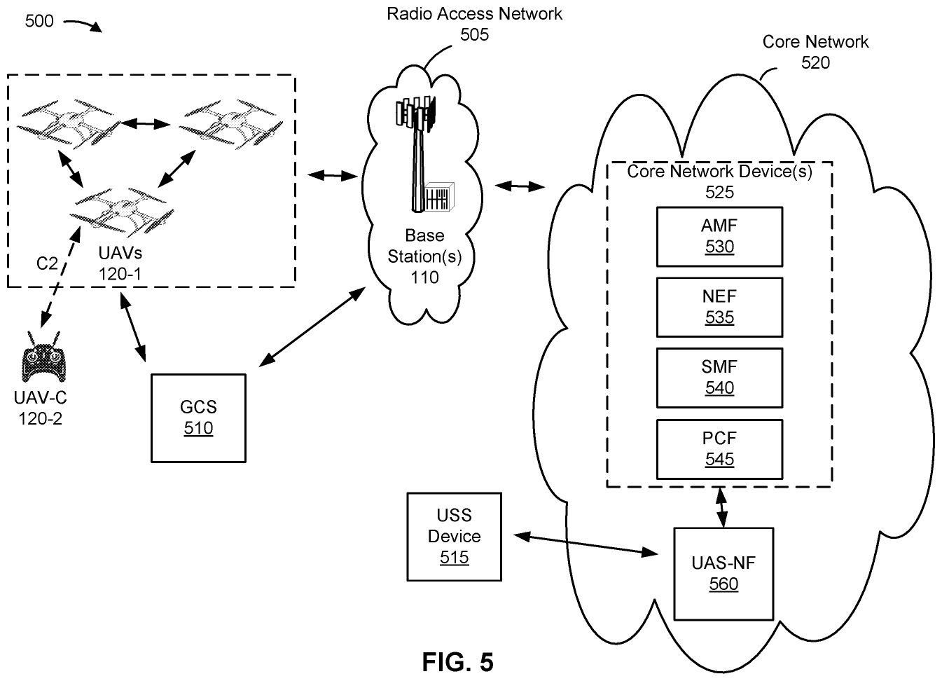

FIG. 5 is a diagram illustrating an example of UAV UEs 120 within a wireless communication network environment 500, in accordance with the present disclosure. As shown in FIG. 5, the environment 500 can include one or more UEs 120, which may include one or more UAVs 120-1 and one or more UAV controllers (UAV-Cs) 120-2, a RAN 505, a core network 520, a UAV service supplier (USS) device 515, and a ground control system (GCS) 510. Devices of environment 500 can interconnect via wired connections, wireless connections, or a combination of wired and wireless connections.

The UAV 120-1 (also referred to herein as a UAV UE 120-1) includes an aircraft without a human pilot aboard and can also be referred to as an unmanned aircraft (UA), a drone, a remotely piloted vehicle (RPV), a remotely piloted aircraft (RPA), a remotely operated aircraft (ROA), or an uncrewed aerial vehicle. The UAV 120-1 may have a variety of shapes, sizes, configurations, characteristics, or the like for a variety of purposes and applications. In some implementations, the UAV 120-1 may include one or more sensors, such as an electromagnetic spectrum sensor (e.g., a visual spectrum, infrared, or near infrared camera, a radar system, or the like), a biological sensor, a temperature sensor, and/or a chemical sensor, among other examples. In some implementations, the UAV 120-1 may include one or more components for communicating with one or more base stations 110. Additionally, or alternatively, the UAV 120-1 may transmit information to and/or receive information from the GCS 510, such as sensor data, flight plan information, or the like. Such information can be communicated directly (e.g., via an RRC signal and/or the like) and/or via the base stations 110 on the RAN 505. The UAV 120-1 may be a component of an unmanned aircraft system (UAS). The UAS may include the UAV 120-1, a UAV-C 120-2 (also referred to herein as a UAV-C UE 120-2), and a system of communication (such as wireless network environment 500 or another system of communication) between the UAV 120-1 and the UAV-C 120-2.

The RAN 505 may include one or more base stations 110 that provide access for the UAV UEs 120 to the core network 520. For example, the RAN 505 may include one or more aggregated base stations and/or one or more disaggregated base stations (e.g., including one or more CUs, one or more DUs, and/or one or more RUs). The UAV 120-1 may communicate with the base station 110 via the Uu interface. For example, the UAV 120-1 may transmit communications to the base station 110 and/or receive communications from the base station 110 via the Uu interface. Such Uu connectivity may be used to support different applications for the UAV 120-1, such as video transmission from the UAV 120-1 or C2 communications for remote command and control of the UAV 120-1, among other examples.

The GCS 510 may include one or more devices capable of managing the UAV 120-1 and/or flight plans for the UAV 120-1. For example, the GCS 510 may include a server device, a desktop computer, a laptop computer, or a similar device. In some examples, the GCS 510 may communicate with one or more devices of the environment 500 (e.g., the UAV 120-1, the USS device 515, and/or the like) to receive information regarding flight plans for the UAV UEs 120-1 and/or to provide recommendations associated with such flight plans, as described elsewhere herein. In some implementations, the GCS 510 may permit a user to control one or more of the UAVs 120-1 (e.g., via the UAV-C 120-2). Additionally, or alternatively, the GCS 510 can use a neural network and/or other artificial intelligence (AI) to control one or more of the UAVs 120-1. In some implementations, the GCS 510 may be included in a data center, a cloud computing environment, a server farm, or the like, which may include multiple GCSs 510. While shown as being external from the core network 520 in FIG. 5, in some aspects, the GCS 510 may reside at least partially within the core network 520.

The USS device 515 includes one or more devices capable of receiving, storing, processing, and/or providing information associated with the UAV UEs 120 and/or the GCS 510. For example, the USS device 515 can include an application server, a desktop computer, a laptop computer, a tablet computer, a mobile phone, or a similar device. In some implementations, the UAVs 120-1 can interact with the USS device 515 to register a flight plan, receive approval, analysis, and/or recommendations related to a flight plan, or the like. The USS device 515 may register the UAV UE 120 with the USS device 515 by assigning an application-level UAV identifier to the UAV UE 120. The application-level UAV identifier may be an aviation administration (e.g., a regulatory body that governs aviation operation in a jurisdiction in which the USS device 515 and the UAV UE 120 are operating) UAV identifier.

The core network 520 includes a network that enables communications between the RAN 505 (e.g., the base stations 110) and one or more devices and/or networks connected to the core network 520. For example, the core network 520 may be a 5G core network. The core network 520 may include one or more core network devices 525, such as one or more access and mobility management functions (AMFs) (herein after referred to as an “AMF”) 530, one or more network exposure functions (NEFs) (herein after referred to as an “NEF”) 535, one or more session management functions (SMFs) (herein after referred to as an “SMF”) 540, one or more policy control functions (PCFs) (herein after referred to as a “PCF”) 545, and/or other entities and/or functions that provide mobility functions for the UAV UEs 120 and enable the UAV UEs 120 to communicate with other devices of the environment 500.

The AMF 530 may include one or more network devices, such as one or more server devices, capable of managing authentication, activation, deactivation, and/or mobility functions associated with the UAV UE 120 connected to the core network 520. In some implementations, the AMF 530 may perform operations relating to authentication of the UAV 120-1. The AMF 530 may maintain a non-access stratum (NAS) signaling connection with the UAV 120-1.

The NEF 535 may include one or more network exposure devices, such as one or more server devices, capable of exposing capabilities, events, information, or the like in one or more wireless networks to help other devices in the one or more wireless networks discover network services and/or utilize network resources efficiently. In some examples, the NEF 535 may receive traffic from and/or send traffic to the UAV 120-1 via the AMF 530 and the base station 110, and the NEF 535 may receive traffic from and/or send traffic to the USS device 515 via a UAS network function (UAS-NF) 560. In some examples, the NEF 535 may obtain a data structure, such as approval of a flight plan for the UAV 120-1, from the USS device 515 and divide the data structure into a plurality of data segments. In some examples, the NEF 535 may determine a location and/or reachability of the UAV 120-1 and/or a communication capability of the base station 110 to determine how to send the plurality of data segments to the UAV 120-1.

The SMF 540 may include one or more network devices, such as one or more server devices, capable of managing sessions for the RAN 505 and allocating addresses, such as Internet protocol (IP) addresses, to the UAVs 120-1. In some examples, the SMF 540 may perform operations relating to registration of the UAV 120-1. For example, the AMF 530 may receive a registration request from the UAV 120-1 and forward a request to the SMF 540 to create a corresponding packet data unit (PDU) session. The SMF 540 may allocate an address to the UAV 120-1 and establish the PDU session for the AMF 530.

The PCF 545 may include one or more network devices, such as one or more server devices, capable of managing traffic to and from the UAV UEs 120 through the RAN 505 and enforcing a QoS on the RAN 505. In some examples, the PCF 545 may implement charging rules and flow control rules, manage traffic priority, and/or manage a QoS for the UAVs 120-1.

The USS device 515 may communicate with the core network 520 using the UAS-NF 560. The UAS-NF 560 may be a service-based interface to enable the USS device 515 to provide information to the core network 520. For example, the USS device 515 may provide, via the UAS-NF 560, registration information associated with a registration between the UAV 120-1 and the USS device 515. The UAS-NF 560 may include a device, such as a server device, that is external to the core network 520, or the UAS-NF 560 may reside, at least partially, on a core network device 525 within the core network 520. In some aspects, the UAS-NF 560 may be co-located with the NEF 535. In some aspects, or more of the core network device(s) 525 and/or the UAS-NF 560 may correspond to network controller 130, as described above in connection with FIG. 1.

The UAV-C 120-2 may remotely control the UAV 120-2 by transmitting C2 communications to the UAV 120-1 and/or receiving C2 communications from the UAV 120-1. In some examples, the UAV-C 120-2 and the UAV 120-1 may use the Uu interface for the C2 communications. For example, the UAV-C 120-2 may transmit C2 communications to UAV 120-1 (and receive C2 communications from the UAV 120-1) via the base station 110. In some examples, the UAV-C 120-2 and the UAV 120-1 may use a non-cellular communication system (e.g., non-3GPP connectivity), such as wireless fidelity (Wi-Fi), for the C2 communications. Currently, NR, in the specification promulgated by 3GPP, does not support transmission of C2 communications via the PC5 interface. However, in some cases, the UAV-C 120-2 may be capable of communicating via the PC5 interface, but may not have Uu capability. Furthermore, because PC5 can cover a longer distance than Wi-Fi, transmission of C2 communications via PC5 unicast communications may result in an increased range of the C2 communications, as compared with Wi-Fi. In addition, transmission of C2 communications via PC5 unicast communications (e.g., via a PC5 direct link between the UAV 120-1 and the UAV-C 120-2) may result in decreased latency, as compared with C2 communications transmitted via the base station 110 using the Uu interface.

In some examples, the UAV 120-1 may have a subscription with a mobile network operator (MNO) of a 5G system (5GS) (e.g., a 5GS including the core network 520 and the RAN 505), and the UAV 120-1 may be registered with the 5GS. In this case, the 5GS may control the PC5 policy for the UAV 120-1. However, in some cases, the UAV-C 120-2 may not have a subscription with the MNO, and the UAV-C may not be registered with the 5GS. In this case, if the UAV 120-1 and UAV-C 120-2 are preconfigured with a PC5 policy (e.g., by the USS device 515), the UAV-C may establish a PC5 direct link with the UAV 120-1 without governance by the MNO (e.g., by the core network device(s) 525). This may result in the UAV-C 120-2 transmitting C2 communications to the UAV 120-1 via a PC5 direct link using radio resources managed by the MNO (e.g., in a licensed PC5 band) without authorization from the MNO. There is currently no mechanism to control and/or authorize communications via a PC5 direct link for a UE which has not registered with the 5GS (and does not have a subscription with the MNO).

Some techniques and apparatuses described herein enable a network entity to receive, from an application server, an authorization request for C2 communications via a direct link between a pair of UEs (e.g., a UAV UE and a UAV-C UE). The authorization request may indicate a ProSe identifier associated with the C2 communications between the pair of UEs. The network entity may transmit, to the application server, an authorization indication for the C2 communications via the direct link between the pair of UEs, and the authorization indication may indicate a destination layer-2 identifier associated with the ProSe identifier. In some aspects, the application server may transmit, to the pair of UEs, the ProSe identifier, and the pair of UEs may establish a direct link (e.g., a PC5 direct link) using the ProSe identifier and the associated destination layer-2 identifier. In some aspects, because the ProSe identifier is assigned for the C2 communications between a specific pair of UEs, once the C2 communications via the direct link between the pair of UEs are authorized, the ProSe identifier may be used to identify the authorized pair of UEs during the direct link (e.g., PC5 direct link) establishment procedure. As a result, C2 communications on a direct link (e.g., a PC5 direct link) between a UAV UE and a UAV-C UE may be authorized (e.g., by a PCF in a core network), even if the UAV-C UE is not registered with the core network.

As indicated above, FIG. 5 is provided as an example. Other examples may differ from what is described with respect to FIG. 5.

FIG. 6 is a diagram illustrating an example 600 associated with authorization of C2 communications via a direct link, in accordance with the present disclosure. As shown in FIG. 6, example 600 includes a UAV UE 120-1, a UAV-C UE 120-2, a RAN node 601 (e.g., base station 110, RU, DU, CU, or a combination thereof), core network device(s) 525, a UAS-NF 560, and an application server 602. The UAV UE 120-1 may communicate with the RAN node 601 via a wireless access link (e.g., via the Uu interface), which may include an uplink and a downlink.

As described above in connection with FIG. 5, the core network device(s) 525 may include the AMF 530, the NEF 535, the SMF 540, and/or the PCF 545, among other examples. In some aspects, the UAV UE 120-1 may communicate with the core network device(s) 525 using NAS signaling. In some aspects, the UAV UE 120-1 may communicate with the core network device(s) 525 via the RAN node 601.

In some aspects, the application server 602 may be, may include, or may be included on, a USS device (e.g., USS device 515 of FIG. 5). The application server 602 may include an application function (AF) of a USS that provides aviation service for the UAV UE 120-1. In some aspects, the AF may access the core network (e.g., access the core network device(s) 525 via the UAS-NF 560) to request authorization to establish a direct unicast link (e.g., a PC5 link) for C2 communications between a pair of UEs (e.g., the UAV UE 120-1 and the UAV-C UE 120-2). The application server 602 may communicate with the core network device(s) 525 using the UAS-NF 560. The UAS-NF 560 may be a network entity, such as a network device associated with and/or included within the core network, or a network entity (e.g., a network device) may include the UAS-NF 560.

As shown in FIG. 6, and by reference number 605, the UAV UE 120-1 and the core network device(s) 525 may perform registration and a USS UAV authentication and authorization (UUAA) procedure. The UAV UE 120-1 and the core network device(s) 525 may perform a registration procedure to register the UAV UE 120-1 with the network. The registration procedure may include the UAV UE 120-1 transmitting, to the core network device(s) 525 (e.g., to the AMF 530) a registration request. In some aspects, the registration request may indicate that the UAV UE 120-1 is registering for aerial services (e.g., UAS services) provided by the network. The core network devices(s) 525 may determine that the UUAA procedure is to be performed for the UAV UE 120-1. For example, the core network devices(s) 525 may obtain subscription information associated with the UAV UE 120-1, and the core network device(s) 525 may determine that the UUAA procedure is to be performed by the UAV UE 120-1 based at least in part on the subscription information. The core network device(s) 525 may perform the UUAA procedure for the UAV UE 120-1 to authenticate the UAV UE 120-1 and authorize the UAV UE 120-1 to use the aerial services (e.g., UAS services) provided by the network. The UUAA procedure may be defined by a regulatory body that governs aviation operation within a jurisdiction in which the UAV UE 120 is operating, such as an aviation authority or an aviation administration.

In some aspects, the UAV-C UE 120-2 may not register with the core network device(s) 525. For example, the UAV-C UE 120-2 may not have a subscription with the MNO associated with the core network, or the UAV-C UE 120-2 may not have Uu capability. In other aspects, the UAV-C UE 120-2 may register with the core network device(s) 525.

As further shown in FIG. 6, and by reference number 610, the UAV UE 120-1 and/or the UAV-C UE 120-2 may communicate with the application server 602 via application layer signaling. For example, application signaling may indicate, to the application server 602, that the UAV UE 120-1 and the UAV-C UE 120-2 are in operation. In some aspects, the application layer signaling may include information relating to a flight plan of the UAV UE 120-1. For example, the UAV UE 120-1 may transmit an indication of a flight plan to the application server 602, and the application server 602 may indicate that the flight plan is authorized (or not authorized). In some aspects, the application signaling may include a request to pair the UAV UE 120-1 and the UAV-C UE 120-2 for C2 communications. For example, the UAV UE 120-1 may transmit, to the application server 602, a request to be paired with the UAV-C UE 120-2 for C2 communications, or the UAV-C UE 120-2 may transmit, to the application server 602, a request to be paired with the UAV UE 120-1 for C2 communications.

As further shown in FIG. 6, and by reference number 615, the application server 602 (e.g., the AF) may determine to pair the UAV UE 120-1 and the UAV-C UE 120-2 for C2 communications via a direct link (e.g., a PC5 direct link), and the application server 602 (e.g., the AF) may assign a ProSe identifier for the C2 communications between that specific pair of UEs (e.g., the UAV UE 120-1 and the UAV-C UE 120-2). In some aspects, the application server 602 may determine to pair the UAV UE 120-1 and the UAV-C UE 120-2 for C2 communications via a PC5 direct link based at least in part on receiving a request, from the UAV UE 120-1, to pair the UAV UE 120-1 and the UAV-C UE 120-2. In some aspects, the application server 602 may determine to pair the UAV UE 120-1 and the UAV-C UE 120-2 for C2 communications via a PC5 direct link based at least in part on receiving a request, from the UAV-C UE 120-2, to pair the UAV UE 120-1 and the UAV-C UE 120-2. In some aspects, the application server 602 may determine to pair the UAV UE 120-1 and the UAV-C UE 120-2 for C2 communications via a PC5 direct link independent of any requests from the UAV UE 120-1 or the UAV-C UE 120-2.

The application server 602 may assign a ProSe identifier that is associated with C2 communications via a PC5 link between the specific pair of UEs (e.g., the UAV UE 120-1 and the UAV-C UE 120-2) determined by the application server 602 to be paired. “ProSe identifier” refers to an identifier used to indicate a ProSe application associated with a ProSe operation in ProSe direct discovery and ProSe direct communication. A ProSe identifier can be associated with one or more ProSe applications, and a ProSe application can be associated with one or more ProSe identifiers. “ProSe direct discovery” refers to a procedure employed by a ProSe-enabled UE to discover one or more other ProSe-enabled UEs in a vicinity of the ProSe-enabled UE, and “ProSe direct communication” refers to a communication between two or more UEs in proximity that are ProSe-enabled via a path not traversing any network node. For ProSe direct discovery, the ProSe identifier may be equivalent to an application ID that identifies a specific application. In some aspects, in a case in which V2X communications are used for the C2 communications between the UAV UE 120-1 and the UAV-C UE 120-2, the ProSe identifier may be a V2X service identifier. In some aspects, the application server 602 may assign a temporarily valid ProSe identifier for the C2 communications between the UAV UE 120-1 and the UAV-C UE 120-2 via a PC5 direct link. In this case, a validity timer may be associated with the ProSe identifier, and the ProSe identifier may be temporarily valid (for establishing a direct PC5 link between the pair of UEs) for a time duration of the validity timer.

As further shown in FIG. 6, and by reference number 620, the application server 602 (e.g., the AF) may transmit, to the UAS-NF 560, an authorization request for C2 communications via a direct link (e.g., a PC5 direct link) between the UAV UE 120-1 and the UAV-C UE 120-2. The UAS-NF 560 may receive the authorization request from the application server 602. The authorization request may be a request, to be submitted to the core network device(s) 525, for authorization to establish a direct PC5 unicast link for C2 communications between a specific pair of UEs (e.g., the UAV UE 120-1 and the UAV-C UE 120-2). The authorization request may include an indication of the ProSe identifier associated with the C2 communications between the UAV UE 120-1 and the UAV-C UE 120-2. The authorization request may also include a UAV identifier (UAV ID) associated with the UAV UE 120-1, a UAV-C identifier (UAV-C ID) associated with the UAV-C UE 120-2, and the time duration of the validity timer associated with the ProSe identifier. In some aspects, the UAV ID may be a general public subscription identifier (GPSI). In some aspects, the UAV ID may be a Civil Aviation Authority (CAA)-level UAV ID. In this case, the core network device(s) 525 may store (e.g., in subscription information of the UAV UE 120-1) a mapping between the CAA-level UAV ID for the UAV UE 120-1 and the GPSI for the UAV UE 120-1. In some aspects (e.g., in a case in which the UAV-C UE 120-2 does not have a subscription with the core network/5GS), the UAV-C ID may be a device ID, such as an International Mobile Equipment Identity (IMEI) or a Mobile Equipment Identifier (MEID).

As further shown in FIG. 6, and by reference number 625, the UAS-NF 560 may transmit, to the core network device(s) 525, a request for PCF authorization of the C2 communications between the UAV UE 120-1 and the UAV-C UE 120-2 via a direct link (e.g., a PC5 direct link). For example, the UAS-NF 560 may transmit a request to the PCF 545 for authorization of C2 communications via a direct PC5 link between the UAV UE 120-1 and the UAV-C UE 120-2. The request for PCF authorization may include an indication of the ProSe identifier associated with the C2 communications between the UAV UE 120-1 and the UAV-C UE 120-2. The request for PCF authorization may also include the UAV ID associated with the UAV UE 120-1, the UAV-C ID associated with the UAV-C UE 120-2, and the time duration of the validity timer associated with the ProSe identifier.

As further shown in FIG. 6, and by reference number 630, the core network device(s) 525 (e.g., the PCF 545) may authorize the request, assign a destination layer-2 identifier for the ProSe identifier, and determine a ProSe policy. The core network device(s) 525 (e.g., the PCF 545) may receive the request for PCF authorization from the UAS-NF 560. The request for PCF authorization may indicate the ProSe identifier that is associated with C2 communications via a direct PC5 link between a specific pair of UEs (e.g., the UAV UE 120-1 and the UAV-C UE 120-2) indicated by the UAV ID and the UAV-C ID. The PCF 545 may determine whether to authorize the pair of UEs (e.g., the UAV UE 120-1 and the UAV-C UE 120-2) to establish a direct PC5 link for C2 communications between the UEs based at least in part on the information included in the request for PCF authorization. For example, the PCF 545 may determine whether to authorize the direct PC5 link for C2 communications between the UAV UE 120-1 and the UAV-C UE 120-2 based at least in part on a determination of whether the UAV UE 120-1 or the UAV-C UE 120-2 is already paired with another UE for C2 communications, and/or based at least in part on an availability of radio resources for transmitting the C2 communications via the PC5 link, among other examples.

In connection with a determination to authorize the C2 communications associated with the ProSe identifier (e.g., a determination to authorize the UAV UE 120-1 and the UAV-C UE 120-2 to establish a direct PC5 link for the C2 communications), the PCF 545 may assign a destination layer-2 identifier that is associated with the ProSe identifier. “Destination layer-2 identifier” refers to a link-layer identity that identifies a device or a group of devices that are recipients of ProSe communication frames. In some aspects, the destination layer-2 identifier assigned by the PCF 545 may be a default destination layer-2 identifier for establishing a direct link for C2 communications. For example, in a case in which the UAV-C UE 120-2 is not registered with the core network, the PCF 545 may assign the default destination layer-2 identifier for the ProSe identifier associated with the C2 communications, and the default destination layer-2 identifier may be used by the UAV UE 120-1 in a link establishment procedure for establishing a direct PC5 link with the UAV-C UE 120-2. This may allow the UAV UE 120-1 to establish the direct PC5 link with the UAV-C UE 120-2, when otherwise the UAV UE 120-1 may not be able to initiate the PC5 direct link establishment procedure due to a missing destination layer-2 identifier.

In some aspects, the PCF 545 may determine (e.g., compose) the ProSe policy associated with the ProSe identifier for the C2 communications and the associated destination layer-2 identifier. The ProSe policy may be a policy to be configured for the UAV UE 120-1 for the communications (e.g., C2 communications) transmitted via the PC5 direct link between the UAV UE 120-1 and the UAV-C UE 120-2. The ProSe policy may indicate parameters, to be used by the UAV UE 120-1, for the C2 communications via the direct PC5 link, such as parameters relating to a security policy and/or parameters relating to the radio resource to be used for the C2 communications via the direct PC5 link, among other examples. In some aspects, in a case in which V2X communications are used for the C2 communications between the UAV UE 120-1 and the UAV-C UE 120-2, the ProSe policy may be a V2X policy.

As further shown in FIG. 6, and by reference number 635, the core network device(s) 525 (e.g., the PCF 545) may transmit an authorization response to the UAS-NF 560. The UAS-NF 560 may receive the authorization response from the core network device(s) 525 (e.g., from the PCF 545). The authorization response may be a response to the request for PCF authorization. For example, the authorization response may indicate whether the C2 communications associated with the ProSe identifier indicated in the request for PCF authorization (e.g., the C2 communications via a direct PC5 link between the UAV UE 120-1 and the UAV-C UE 120-2) are authorized or not authorized. In some aspects, when the C2 communications are authorized by the PCF, the authorization response may indicate the destination layer-2 identifier associated with the ProSe identifier for the C2 communications, and the authorization response may indicate the ProSe policy for the ProSe identifier and the destination layer-2 identifier.

As further shown in FIG. 6, and by reference number 640, the UAS-NF 560 may transmit, to the application server 602, an authorization indication. For example, the UAS-NF 560 may transmit the authorization indication to the application server 602 in connection with receiving the authorization response that indicates that the C2 communications via a direct PC5 link between the UAV UE 120-1 and the UAV-C UE 120-2 are authorized. The application server 602 may receive the authorization indication from the UAS-NF 560. The authorization indication may indicate that the C2 communications associated with the ProSe identifier indicated in the authorization request (e.g., the C2 communications via a direct PC5 link between the UAV UE 120-1 and the UAV-C UE 120-2) are authorized. The authorization indication may indicate the destination layer-2 identifier associated with the ProSe identifier for the C2 communications. The authorization indication may also indicate the ProSe policy for the ProSe identifier for the C2 communications and the destination layer-2 identifier associated with the ProSe identifier (e.g., the default destination layer-2 identifier).

As further shown in FIG. 6, and by reference number 645, the core network device(s) 525 may transmit, to the UAV UE 120-1, an indication of the ProSe policy associated with the ProSe identifier and the destination layer-2 identifier assigned to the Pro-Se identifier. For example, the core network device(s) 525 (e.g., the PCF 545) may transmit the indication of the ProSe policy to the UAV UE 120-1 via NAS signaling or via the RAN node 601. The UAV UE 120-1 may receive the indication of the ProSe policy determined by the PCF 545. The indication of the ProSe policy may configure the ProSe policy to be used by the UAV UE 120-1 for C2 communications associated with the ProSe identifier and the destination layer-2 ID assigned to the ProSe identifier (e.g., the default destination layer-2 identifier). That is, the indication of the ProSe policy may configure the ProSe policy for UAV UE 120-1 for C2 communications via a direct PC5 link established between the UAV UE 120-1 and the UAV-C UE 120-2.

In some aspects, in a case in which the UAV-C UE 120-2 is registered with the core network, the core network device(s) 525 may transmit an indication of the ProSe policy to the UAV-C UE 120-2 to configure the UAV-C UE 120-2 with the ProSe policy for the C2 communications associated with the ProSe identifier and the destination layer-2 identifier.

As further shown in FIG. 6, and by reference number 650, the application server 602 (e.g., the AF) may transmit, to the UAV UE 120-1 and/or the UAV-C UE 120-2, an indication of the ProSe identifier associated with C2 communications via a direct link (e.g., a direct PC5 link) between the UAV UE 120-1 and the UAV-C UE 120-2 and an indication of the time duration of the validity timer associated with the ProSe identifier. In this case, the ProSe identifier may be associated with C2 communications that have been authorized (e.g., by the PCF 545) to be transmitted via a direct link (e.g., a PC5 link) between the UAV UE 120-1 and the UAV-C UE 120-2. The application server 602 (e.g., the AF) may also transmit, to the UAV UE 120-1 and/or the UAV-C UE 120-2, an indication of the destination layer-2 identifier assigned to the ProSe identifier (e.g., the default destination layer-2 identifier). In some aspects, the application server 602 may transmit the indication of the ProSe identifier to an application layer of the UAV UE 120-1 (e.g., via application layer signaling) to be used in an application layer operation by the UAV UE 120-1. Additionally, or alternatively, the application server 602 may transmit the indication of the ProSe identifier to an application layer of the UAV-C UE 120-2 (e.g., via application layer signaling) to be used in an application layer operation by the UAV-C UE 120-2. In some aspects, the application server 602 (e.g., the AF) may also transmit, to the UAV UE 120-1 and/or the UAV-C UE 120-2, an indication of the destination layer-2 identifier assigned to the ProSe identifier (e.g., the default destination layer-2 identifier). In some aspects, the application server 602 may transmit the indication of the time duration of the validity timer to the application layer of the UAV UE 120-1 (e.g., via application layer signaling) to be used in an application layer operation by the UAV UE 120-1. Additionally, or alternatively, the application server 602 may transmit the indication of the time duration of the validity timer to the application layer of the UAV-C UE 120-2 (e.g., via application layer signaling) to be used in an application layer operation by the UAV-C UE 120-2.

In some aspects, the application server 602 (e.g., the AF), may transmit, to the UAV-C UE 120-2, an indication of the ProSe policy associated with the ProSe identifier and the destination layer-2 ID assigned to the ProSe identifier (e.g., the default destination layer-2 identifier). In this case, the application server 602 (e.g., the AF) may transmit the indication of the ProSe policy to the UAV-C UE 120-2 to configure the ProSe policy for the UAV-C UE 120-2 for C2 communications via a direct PC5 link between the UAV-C UE 120-2 and the UAV UE 120-1 (e.g., C2 communications associated with the ProSe identifier and the destination layer-2 identifier).

As further shown in FIG. 6, and by reference number 655, the UAV UE 120-1 and the UAV-C UE 120-2 may establish a direct link (e.g., a direct PC5 link) for C2 communications based at least in part on the ProSe identifier associated with the C2 communications and the destination layer-2 identifier. The ProSe identifier may be associated with C2 communications that have been authorized (e.g., by the PCF 545) to be transmitted via a direct PC5 link between a specific pair of UEs (e.g., the UAV UE 120-1 and the UAV-C UE 120-2). The UAV UE 120-1 and/or the UAV-C UE 120-2 may use the ProSe identifier and the destination layer-2 identifier in a PC5 direct link establishment procedure. In some aspects, the UAV UE 120-1 may initiate the PC5 direct link establishment procedure by transmitting, to the UAV-C UE 120-2, a PC5 direct link establishment request that includes an indication of the ProSe identifier and an indication of the associated destination layer-2 identifier (e.g., the default destination layer-2 identifier). In some aspects, the UAV-C UE 120-2 may initiate the PC5 direct link establishment procedure by transmitting, to the UAV UE 120-1, a PC5 direct link establishment request that includes an indication of the ProSe identifier and an indication of the associated destination layer-2 identifier (e.g., the default destination layer-2 identifier).

In some aspects, the UAV UE 120-1 and the UAV-C UE 120-2 may establish the direct link (e.g., the direct PC5 link) between the UAV UE 120-1 and the UAV-C UE 120-2 before the validity timer associated with the ProSe identifier expires (e.g., within the time duration of the validity timer). For example, the UAV UE 120-1 or the UAV-C UE 120-2 may initiate the PC5 direct link establishment procedure before the validity timer expires. For example, time duration of the validity timer may start when the C2 communications associated with the ProSe identifier are approved by the PCF 545, or the time duration of the validity timer may start when the application server 602 transmits the indication of the ProSe identifier for the approved C2 communications to the UAV UE 120-1 and/or the UAV-C UE 120-2. In some aspects, after the validity timer expires, if the PC5 direct link between the UAV UE 120-1 and the UAV-C UE 120-2 is released (or not yet established), the UAV-C UE 120-2 and the UAV-C UE 120-2 may no longer use the ProSe identifier for C2 communications between the UAV UE 120-1 and the UAV-C UE 120-2.

As further shown in FIG. 6, and by reference number 660, one or more C2 communications may be transmitted between the UAV UE 120-1 and the UAV-C UE 120-2 via the direct link (e.g., the PC5 direct link) between the UAV UE 120-1 and the UAV-C UE 120-2. In some aspects, the UAV-C UE 120-2 may transmit, and the UAV UE 120-1 may receive, one or more C2 communications via the PC5 direct link between the UAV UE 120-1 and the UAV-C UE 120-2. In some aspects, the UAV UE 120-1 may transmit, and the UAV-C UE 120-2 may receive, one or more C2 communications via the PC5 direct link between the UAV UE 120-1 and the UAV-C UE 120-2. For example, the UAV-C UE 120-2 and/or the UAV UE 120-1 may transmit C2 communications via unicast PC5 communications via the PC5 direct link established between the UAV UE 120-1 and the UAV-C UE 120-2.

In some aspects, in a case in which multiple UAV-C UEs are available for C2 communications with the UAV UE 120-1, a handover of remote control between UAV-C UEs may be performed. In this case, the temporarily valid ProSe identifier for the C2 communications may be assigned to a specific pair of the UAV UE 120-1 and a list of UAV-C UEs (e.g., including the UAV-C UE 120-2). As long as there is another UAV-C UE using the same ProSe identifier for C2 communications via the PC5 interface, the UAV UE 120-1 may switch from a PC5 link established with one UAV-C UE to a PC5 link established with another UAV-C, for example, depending on a flight location of the UAV UE 120-1. The UAV UE 120-1 may release the PC5 link with one UAV-C UE after a decision to handover the control of the UAV UE 120-1 to a new UAV-C UE. For example, the UAV UE 120-1 may release the direct link (e.g., the PC5 direct link) established with the UAV-C UE 120-2, and the UAV UE 120-1 may establish a direct link (e.g., a PC5 link) with another UAV-C based at least in part on the same ProSe identifier and destination layer-2 identifier as used for establishing the direct link with the UAV-C UE 120-2.

As indicated above, FIG. 6 is provided as an example. Other examples may differ from what is described with respect to FIG. 6.

FIG. 7 is a diagram illustrating an example process 700 performed, for example, by a first UE, in accordance with the present disclosure. Example process 700 is an example where the first UE (e.g., UAV UE 120-1 or UAV-C UE 120-2) performs operations associated with authorization of C2 communications via a direct link.

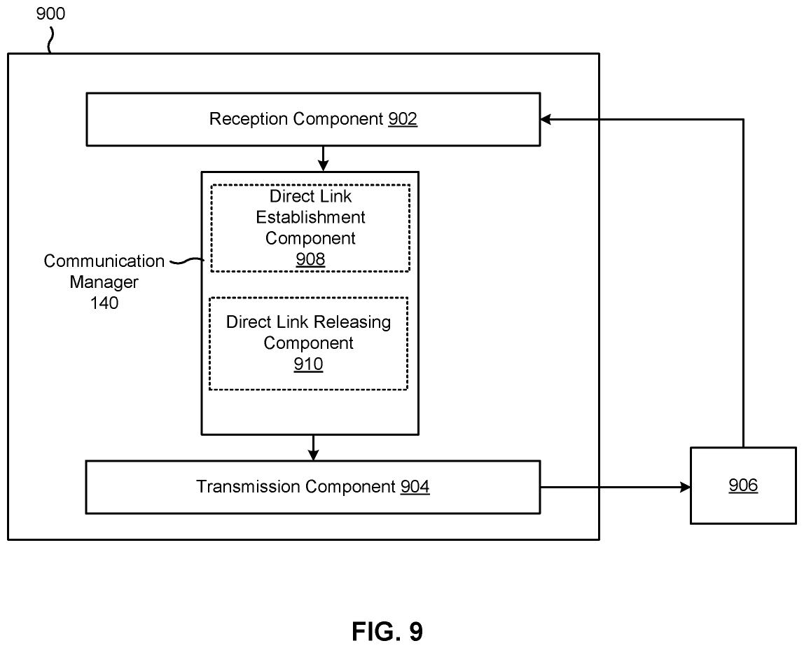

As shown in FIG. 7, in some aspects, process 700 may include receiving an indication of a ProSe identifier associated with authorized C2 communications via a direct link between the first UE and a second UE, and an indication of a destination layer-2 identifier associated with the ProSe identifier (block 710). For example, the first UE (e.g., using communication manager 140 and/or reception component 902, depicted in FIG. 9) may receive an indication of a ProSe identifier associated with authorized C2 communications via a direct link between the first UE and a second UE, and an indication of a destination layer-2 identifier associated with the ProSe identifier, as described above.

As further shown in FIG. 7, in some aspects, process 700 may include establishing a direct link with the second UE based at least in part on the ProSe identifier and the destination layer-2 identifier (block 720). For example, the first UE (e.g., using communication manager 140 and/or direct link establishment component 908, depicted in FIG. 9) may establish a direct link with the second UE based at least in part on the ProSe identifier and the destination layer-2 identifier, as described above.

Process 700 may include additional aspects, such as any single aspect or any combination of aspects described below and/or in connection with one or more other processes described elsewhere herein.

In a first aspect, process 700 includes receiving an indication of a time duration for a validity timer associated with the ProSe identifier, wherein establishing the direct link with the second UE comprises establishing the direct link with the second UE based at least in part on the ProSe identifier and the destination layer-2 identifier within the time duration for the validity timer associated with the ProSe identifier.

In a second aspect, the ProSe identifier is associated with C2 communications via the direct link between first UE and the second UE that are authorized based at least in part on an authorization request from an application server.

In a third aspect, process 700 includes receiving an indication of a ProSe policy associated with the ProSe identifier and the destination layer-2 identifier.

In a fourth aspect, the ProSe identifier is a V2X service identifier and the ProSe policy is a V2X policy.

In a fifth aspect, receiving the indication of the ProSe identifier and the indication of the destination layer-2 identifier comprises receiving the indication of the ProSe identifier and the indication of the destination layer-2 identifier from an application server.

In a sixth aspect, receiving the indication of the ProSe identifier and the indication of the destination layer-2 identifier comprises receiving the indication of the ProSe identifier and the indication of the destination layer-2 identifier from a network entity.

In a seventh aspect, the first UE is a UAV and the second UE is a UAV-C.

In an eighth aspect, process 700 includes receiving, from the second UE, one or more C2 communications via the direct link with the second UE.

In a ninth aspect, process 700 includes releasing the direct link with the second UE, and establishing a direct link with a third UE based at least in part on the ProSe identifier and the destination layer-2 identifier, wherein the third UE is another UAV-C.

In a tenth aspect, the first UE is a UAV-C and the second UE is a UAV.

In an eleventh aspect, process 700 includes transmitting, to the second UE, one or more C2 communications via the direct link with the second UE.

In a twelfth aspect, establishing the direct link with the second UE based at least in part on the ProSe identifier and the destination layer-2 identifier comprises establishing a PC5 direct link with the second UE based at least in part on the ProSe identifier and the destination layer-2 identifier.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., UAS-NF 560) performs operations associated with authorization of C2 communications via a direct link.

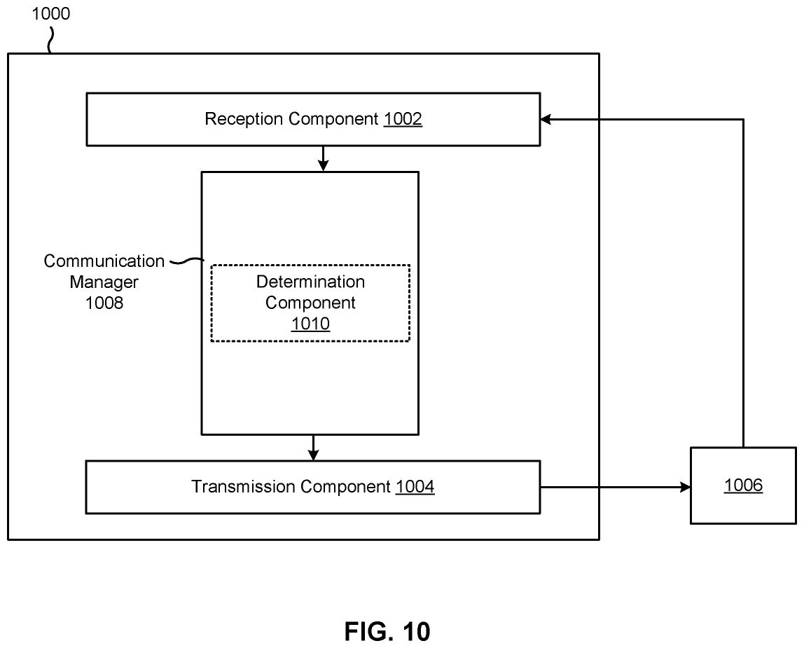

As shown in FIG. 8, in some aspects, process 800 may include receiving, from an application server, an authorization request for C2 communications via a direct link between a pair of UEs, wherein the authorization request indicates a ProSe identifier associated with the C2 communications (block 810). For example, the network entity (e.g., using communication manager 1008 and/or reception component 1002, depicted in FIG. 10) may receive, from an application server, an authorization request for C2 communications via a direct link between a pair of UEs, wherein the authorization request indicates a ProSe identifier associated with the C2 communications, as described above.

As further shown in FIG. 8, in some aspects, process 800 may include transmitting, to the application server, an authorization indication for the C2 communications via the direct link between the pair of UEs, wherein the authorization indication indicates a destination layer-2 identifier associated with the ProSe identifier (block 820). For example, the network entity (e.g., using communication manager 1008 and/or transmission component 1004, depicted in FIG. 10) may transmit, to the application server, an authorization indication for the C2 communications via the direct link between the pair of UEs, wherein the authorization indication indicates a destination layer-2 identifier associated with the ProSe identifier, as described above.

Process 800 may include additional aspects, such as any single aspect or any combination of aspects described below and/or in connection with one or more other processes described elsewhere herein.

In a first aspect, the pair of UEs includes a UAV and a UAV-C.

In a second aspect, the authorization request indicates a UAV identifier associated with the UAV and a UAV-C identifier associated with the UAV-C.

In a third aspect, the authorization request indicates a time duration for a validity timer associated with the ProSe identifier.

In a fourth aspect, the authorization indication indicates a ProSe policy for the ProSe identifier and the destination layer-2 identifier.

In a fifth aspect, process 800 includes transmitting, to a core network device, a request for PCF authorization of the C2 communications via the direct link between the pair of UEs, and receiving, from the core network device, an indication of the destination layer-2 identifier associated with the ProSe identifier and an indication of the ProSe policy for the ProSe identifier and the destination layer-2 identifier.

In a sixth aspect, the destination layer-2 identifier is a default destination layer-2 identifier for establishing a direct link for C2 communications.

In a seventh aspect, the authorization request is a request for authorization for C2 communications via a PC5 direct link between the pair of UEs.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a direct link establishment component 908 and/or a direct link releasing component 910, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive an indication of a ProSe identifier associated with authorized C2 communications via a direct link between the first UE and a second UE, and an indication of a destination layer-2 identifier associated with the ProSe identifier. The direct link establishment component 908 may establish a direct link with the second UE based at least in part on the ProSe identifier and the destination layer-2 identifier.

The reception component 902 may receive an indication of a time duration for a validity timer associated with the ProSe identifier, wherein establishing the direct link with the second UE comprises establishing the direct link with the second UE based at least in part on the ProSe identifier and the destination layer-2 identifier within the time duration for the validity timer associated with the ProSe identifier.

The reception component 902 may receive an indication of a ProSe policy associated with the ProSe identifier and the destination layer-2 identifier.

The reception component 902 may receive, from the second UE, one or more C2 communications via the direct link with the second UE.

The direct link releasing component 910 may release the direct link with the second UE.

The direct link establishment component 908 may establish a direct link with a third UE based at least in part on the ProSe identifier and the destination layer-2 identifier, wherein the third UE is another UAV-C.

The transmission component 904 may transmit, to the second UE, one or more C2 communications via the direct link with the second UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity, or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008. The communication manager 1008 may include a determination component 1010, among other examples.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The reception component 1002 may receive, from an application server, an authorization request for C2 communications via a direct link between a pair of UEs, wherein the authorization request indicates a ProSe identifier associated with the C2 communications. The transmission component 1004 may transmit, to the application server, an authorization indication for the C2 communications via the direct link between the pair of UEs, wherein the authorization indication indicates a destination layer-2 identifier associated with the ProSe identifier.

The transmission component 1004 may transmit, to a core network device, a request for PCF authorization of the C2 communications via the direct link between the pair of UEs.

The reception component 1002 may receive, from the core network device, an indication of the destination layer-2 identifier associated with the ProSe identifier and an indication of the ProSe policy for the ProSe identifier and the destination layer-2 identifier.

The determination component 1010 may determine the request for PCF authorization based at least in part on the authorization request.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a first user equipment (UE), comprising: receiving an indication of a proximity-based services (ProSe) identifier associated with authorized command and control (C2) communications via a direct link between the first UE and a second UE and an indication of a destination layer-2 identifier associated with the ProSe identifier; and establishing a direct link with the second UE based at least in part on the ProSe identifier and the destination layer-2 identifier.
Aspect 2: The method of Aspect 1, further comprising: receiving an indication of a time duration for a validity timer associated with the ProSe identifier, wherein establishing the direct link with the second UE comprises establishing the direct link with the second UE based at least in part on the ProSe identifier and the destination layer-2 identifier within the time duration for the validity timer associated with the ProSe identifier.
Aspect 3: The method of any of Aspects 1-2, wherein the ProSe identifier is associated with C2 communications via the direct link between first UE and the second UE that are authorized based at least in part on an authorization request from an application server.
Aspect 4: The method of any of Aspects 1-3, further comprising: receiving an indication of a ProSe policy associated with the ProSe identifier and the destination layer-2 identifier.
Aspect 5: The method of Aspect 4, wherein the ProSe identifier is a vehicle-to-everything (V2X) service identifier and the ProSe policy is a V2X policy.
Aspect 6: The method of any of Aspects 1-5, wherein receiving the indication of the ProSe identifier and the indication of the destination layer-2 identifier comprises: receiving the indication of the ProSe identifier and the indication of the destination layer-2 identifier from an application server.
Aspect 7: The method of any of Aspects 1-6, wherein receiving the indication of the ProSe identifier and the indication of the destination layer-2 identifier comprises: receiving the indication of the ProSe identifier and the indication of the destination layer-2 identifier from a network entity.
Aspect 8: The method of any of Aspects 1-7, wherein the first UE is an unmanned aerial vehicle (UAV) and the second UE is an unmanned aerial vehicle controller (UAV-C).
Aspect 9: The method of Aspect 8, further comprising: receiving, from the second UE, one or more C2 communications via the direct link with the second UE.
Aspect 10: The method of any of Aspects 8-9, further comprising: releasing the direct link with the second UE; and establishing a direct link with a third UE based at least in part on the ProSe identifier and the destination layer-2 identifier, wherein the third UE is another UAV-C.
Aspect 11: The method of any of Aspects 1-7, wherein the first UE is an unmanned aerial vehicle controller (UAV-C) and the second UE is an unmanned aerial vehicle (UAV).
Aspect 12: The method of Aspect 11, further comprising: transmitting, to the second UE, one or more C2 communications via the direct link with the second UE.
Aspect 13: The method of any of Aspects 1-12, wherein establishing the direct link with the second UE based at least in part on the ProSe identifier and the destination layer-2 identifier comprises: establishing a PC5 direct link with the second UE based at least in part on the ProSe identifier and the destination layer-2 identifier.
Aspect 14: A method of wireless communication performed by a network entity, comprising: receiving, from an application server, an authorization request for command and control (C2) communications via a direct link between a pair of user equipments (UEs), wherein the authorization request indicates a proximity-based services (ProSe) identifier associated with the C2 communications; and transmitting, to the application server, an authorization indication for the C2 communications via the direct link between the pair of UEs, wherein the authorization indication indicates a destination layer-2 identifier associated with the ProSe identifier.
Aspect 15: The method of Aspect 14, wherein the pair of UEs includes an unmanned aerial vehicle (UAV) and an unmanned aerial vehicle controller (UAV-C).
Aspect 16: The method of Aspect 15, wherein the authorization request indicates a UAV identifier associated with the UAV and a UAV-C identifier associated with the UAV-C.
Aspect 17: The method of any of Aspects 14-16, wherein the authorization request indicates a time duration for a validity timer associated with the ProSe identifier.
Aspect 18: The method of any of Aspects 14-17, wherein the authorization indication indicates a ProSe policy for the ProSe identifier and the destination layer-2 identifier.
Aspect 19: The method of Aspect 18, further comprising: transmitting, to a core network device, a request for policy control function (PCF) authorization of the C2 communications via the direct link between the pair of UEs; and receiving, from the core network device, an indication of the destination layer-2 identifier associated with the ProSe identifier and an indication of the ProSe policy for the ProSe identifier and the destination layer-2 identifier.
Aspect 20: The method of any of Aspects 18-19, wherein the destination layer-2 identifier is a default destination layer-2 identifier for establishing a direct link for C2 communications.
Aspect 21: The method of any of Aspects 14-20, wherein the authorization request is a request for authorization for C2 communications via a PC5 direct link between the pair of UEs.
Aspect 22: An apparatus for wireless communication at a device, comprising a processor; memory coupled with the processor; and instructions stored in the memory and executable by the processor to cause the apparatus to perform the method of one or more of Aspects 1-13.
Aspect 23: A device for wireless communication, comprising a memory and one or more processors coupled to the memory, the one or more processors configured to perform the method of one or more of Aspects 1-13.
Aspect 24: An apparatus for wireless communication, comprising at least one means for performing the method of one or more of Aspects 1-13.
Aspect 25: A non-transitory computer-readable medium storing code for wireless communication, the code comprising instructions executable by a processor to perform the method of one or more of Aspects 1-13.
Aspect 26: A non-transitory computer-readable medium storing a set of instructions for wireless communication, the set of instructions comprising one or more instructions that, when executed by one or more processors of a device, cause the device to perform the method of one or more of Aspects 1-13.
Aspect 27: An apparatus for wireless communication at a device, comprising a processor; memory coupled with the processor; and instructions stored in the memory and executable by the processor to cause the apparatus to perform the method of one or more of Aspects 14-21.
Aspect 28: A device for wireless communication, comprising a memory and one or more processors coupled to the memory, the one or more processors configured to perform the method of one or more of Aspects 14-21.
Aspect 29: An apparatus for wireless communication, comprising at least one means for performing the method of one or more of Aspects 14-21.
Aspect 30: A non-transitory computer-readable medium storing code for wireless communication, the code comprising instructions executable by a processor to perform the method of one or more of Aspects 14-21.
Aspect 31: A non-transitory computer-readable medium storing a set of instructions for wireless communication, the set of instructions comprising one or more instructions that, when executed by one or more processors of a device, cause the device to perform the method of one or more of Aspects 14-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
receive an indication of a proximity-based services (ProSe) identifier associated with authorized command and control (C2) communications via a direct link between the first UE and a second UE and an indication of a destination layer-2 identifier associated with the ProSe identifier; and
establish a direct link with the second UE based at least in part on the ProSe identifier and the destination layer-2 identifier.

2. The UE of claim 1, wherein the one or more processors are further configured to:
receive an indication of a time duration for a validity timer associated with the ProSe identifier, wherein establishing the direct link with the second UE comprises establishing the direct link with the second UE based at least in part on the ProSe identifier and the destination layer-2 identifier within the time duration for the validity timer associated with the ProSe identifier.

3. The UE of claim 1, wherein the ProSe identifier is associated with C2 communications via the direct link between first UE and the second UE that are authorized based at least in part on an authorization request from an application server.

4. The UE of claim 1, wherein the one or more processors are further configured to:
receive an indication of a ProSe policy associated with the ProSe identifier and the destination layer-2 identifier, wherein the ProSe identifier is a vehicle-to-everything (V2X) service identifier and the ProSe policy is a V2X policy.

5. The UE of claim 1, wherein the one or more processors, to receive the indication of the ProSe identifier and the indication of the destination layer-2 identifier, are configured to:
receive the indication of the ProSe identifier and the indication of the destination layer-2 identifier from an application server.

6. The UE of claim 1, wherein the one or more processors, to receive the indication of the ProSe identifier and the indication of the destination layer-2 identifier, are configured to:
receive the indication of the ProSe identifier and the indication of the destination layer-2 identifier from a network entity.

7. The UE of claim 1, wherein the first UE is an unmanned aerial vehicle (UAV) and the second UE is an unmanned aerial vehicle controller (UAV-C).

8. The UE of claim 7, wherein the one or more processors are further configured to:
receive, from the second UE, one or more C2 communications via the direct link with the second UE.

9. The UE of claim 7, wherein the one or more processors are further configured to:
release the direct link with the second UE; and
establish a direct link with a third UE based at least in part on the ProSe identifier and the destination layer-2 identifier, wherein the third UE is another UAV-C.

10. The UE of claim 1, wherein the first UE is an unmanned aerial vehicle controller (UAV-C) and the second UE is an unmanned aerial vehicle (UAV).

11. The UE of claim 10, wherein the one or more processors are further configured to:
transmit, to the second UE, one or more C2 communications via the direct link with the second UE.

12. The UE of claim 1, wherein the one or more processors, to establish the direct link with the second UE based at least in part on the ProSe identifier and the destination layer-2 identifier, are configured to:
establish a PC5 direct link with the second UE based at least in part on the ProSe identifier and the destination layer-2 identifier.

13. A network entity for wireless communication, comprising:
a memory; and
one or more processors, coupled to the memory, configured to:
receive, from an application server, an authorization request for command and control (C2) communications via a direct link between a pair of user equipments (UEs), wherein the authorization request indicates a proximity-based services (ProSe) identifier associated with the C2 communications; and
transmit, to the application server, an authorization indication for the C2 communications via the direct link between the pair of UEs, wherein the authorization indication indicates a destination layer-2 identifier associated with the ProSe identifier.

14. The network entity of claim 13, wherein the pair of UEs includes an unmanned aerial vehicle (UAV) and an unmanned aerial vehicle controller (UAV-C).

15. The network entity of claim 14, wherein the authorization request indicates a UAV identifier associated with the UAV and a UAV-C identifier associated with the UAV-C.

16. The network entity of claim 13, wherein the authorization request indicates a time duration for a validity timer associated with the ProSe identifier.

17. The network entity of claim 13, wherein the authorization indication indicates a ProSe policy for the ProSe identifier and the destination layer-2 identifier, and wherein the one or more processors are further configured to:
transmit, to a core network device, a request for policy control function (PCF) authorization of the C2 communications via the direct link between the pair of UEs; and
receive, from the core network device, an indication of the destination layer-2 identifier associated with the ProSe identifier and an indication of the ProSe policy for the ProSe identifier and the destination layer-2 identifier.

18. The network entity of claim 17, wherein the destination layer-2 identifier is a default destination layer-2 identifier for establishing a direct link for C2 communications.

19. The network entity of claim 13, wherein the authorization request is a request for authorization for C2 communications via a PC5 direct link between the pair of UEs.

20. A method of wireless communication performed by a first user equipment (UE), comprising:
receiving an indication of a proximity-based services (ProSe) identifier associated with authorized command and control (C2) communications via a direct link between the first UE and a second UE and an indication of a destination layer-2 identifier associated with the ProSe identifier; and
establishing a direct link with the second UE based at least in part on the ProSe identifier and the destination layer-2 identifier.

21. The method of claim 20, further comprising:
receiving an indication of a time duration for a validity timer associated with the ProSe identifier, wherein establishing the direct link with the second UE comprises establishing the direct link with the second UE based at least in part on the ProSe identifier and the destination layer-2 identifier within the time duration for the validity timer associated with the ProSe identifier.

22. The method of claim 20, wherein the ProSe identifier is associated with C2 communications via the direct link between first UE and the second UE that are authorized based at least in part on an authorization request from an application server.

23. The method of claim 20, wherein receiving the indication of the ProSe identifier and the indication of the destination layer-2 identifier comprises:
receiving the indication of the ProSe identifier and the indication of the destination layer-2 identifier from an application server.

24. The method of claim 20, wherein receiving the indication of the ProSe identifier and the indication of the destination layer-2 identifier comprises:
receiving the indication of the ProSe identifier and the indication of the destination layer-2 identifier from a network entity.

25. The method of claim 20, wherein the first UE is an unmanned aerial vehicle (UAV) and the second UE is an unmanned aerial vehicle controller (UAV-C), and wherein the method further comprises:
receiving, from the second UE, one or more C2 communications via the direct link with the second UE.

26. The method of claim 25, further comprising:
releasing the direct link with the second UE; and
establishing a direct link with a third UE based at least in part on the ProSe identifier and the destination layer-2 identifier, wherein the third UE is another UAV-C.

27. The method of claim 20, wherein the first UE is an unmanned aerial vehicle controller (UAV-C) and the second UE is an unmanned aerial vehicle (UAV), and wherein the method further comprises:
transmitting, to the second UE, one or more C2 communications via the direct link with the second UE.

28. A method of wireless communication performed by a network entity, comprising:
receiving, from an application server, an authorization request for command and control (C2) communications via a direct link between a pair of user equipments (UEs), wherein the authorization request indicates a proximity-based services (ProSe) identifier associated with the C2 communications; and
transmitting, to the application server, an authorization indication for the C2 communications via the direct link between the pair of UEs, wherein the authorization indication indicates a destination layer-2 identifier associated with the ProSe identifier.

29. The method of claim 28, wherein the pair of UEs includes an unmanned aerial vehicle (UAV) and an unmanned aerial vehicle controller (UAV-C), and wherein the authorization request indicates a UAV identifier associated with the UAV and a UAV-C identifier associated with the UAV-C.

30. The method of claim 28, wherein the authorization request indicates a time duration for a validity timer associated with the ProSe identifier.
